(19) United States
(12) Patent Application Publication
(10) Pub. No.: US 2024/0344786 A1
(43) Pub. Date: Oct. 17, 2024

(54) MACHINE LEARNING BASED TIME-TO-EVENT MODELS FOR OPTIMIZING ASSET HEALTH AND PROGNOSTICS

(71) Applicant: Baker Hughes Holdings LLC, Houston, TX (US)

(72) Inventors: Prashant Rai, Sacra,emtp, CA (US); Nikhil Gulati, San Jose, CA (US); Marcio Andre Affonso, Jandira (BR)

(21) Appl. No.: 18/627,820

(22) Filed: Apr. 5, 2024

Related U.S. Application Data
(60) Provisional application No. 63/459,684, filed on Apr. 16, 2023.

(51) Int. Cl. F28F 27/00

(52) U.S. Cl. CPC F28F 27/00; F28F 2265/10; F28F 2265/12

(57) ABSTRACT

A system for determining a cleaning schedule for an asset is provided. In some aspects, the system can include a plurality of sensors arranged to monitor an asset and a computing system including at least one data processor and memory storing instructions, which when executed by the at least on data processor causes the at least one data processor to perform operations. In some aspects, the operations performed by the processor can include receiving, from the plurality of sensors, the data characterizing the operational efficiency of the asset, determining an operational efficiency of the asset determining an operational efficiency threshold characterizing an undesirable operating efficiency, determining, using an optimization algorithm, a cleaning schedule for the asset based on the operational efficiency of the asset and the operational efficiency threshold and providing the cleaning schedule.

### RELATED APPLICATION

This application claims priority under 35 U.S.C. § 119 (e) to U.S. Provisional Application No. 63/459,684 filed Apr. 16, 2023, the entire contents of which are hereby expressly incorporated by reference herein.

### BACKGROUND

Over the course of operating industrial assets, such as heat exchangers and compressors, accumulation of unwanted deposits or contaminants can develop on the surfaces thereof. This accumulation is referred to as fouling. Fouling within industrial assets can affect operational efficiency of assets, increase operational costs and damage the assets. For example, fouling can hinder heat transfer efficiency in heat exchangers and can constrict flow passages within heat exchangers and compressors, leading to reduced flow rates, increased pressure drops, and potential operational issues such as cavitation.

### SUMMARY

In one aspect, a method for determining a cleaning schedule for an asset is provided. In some aspects, the method can include acquiring, from a plurality of sensors arranged to monitor an asset, data characterizing an operational efficiency of the asset over time, receiving, via a computing system including at least one data processor and a memory storing instructions, the data characterizing the operational efficiency of the asset, determining, by the at least one data processor, an operational efficiency of the asset and an operational efficiency threshold characterizing an undesirable operating efficiency, determining, by the at least one data processor, a cleaning schedule for the asset based on the operational efficiency of the asset and the operational efficiency threshold and providing the cleaning schedule.

In some aspects, the cleaning schedule includes one or more minor cleanings for non-invasive cleaning of the asset. In some aspects, the cleaning schedule includes one or more major cleaning for mechanical cleaning of the asset.

In some aspects, the method can further include determining, by the at least one data processor, a predicted time to event corresponding to a time that the operational efficiency threshold will be reached and providing the time to event.

In some aspects, the method can further include receiving, via the computing system, from the asset, data characterizing one or more operating states of the asset and determining the cleaning schedule, by the at least one data processor, using an optimization algorithm, based on the operational efficiency of the asset, the operational efficiency threshold and the data characterizing the one or more operating states of the asset.

In some aspects, the method can further include determining, by the at least one data processor, using the optimization algorithm, an optimized operating schedule for operation of the asset in the one or more operating states. In some aspects, the predicted time to event can be determined based on the cleaning schedule and the optimized operating schedule.

In some aspects, the method can further include determining, by the at least one data processor, an amount of fouling that has developed in the asset.

In some aspects, the asset can be a heat exchanger or a compressor, and the plurality of sensors include at least one of temperature sensors and pressure sensors.

In some aspects, the operational efficiency threshold can be determined based on at least one of historical operational data of the asset, a client preference, a predetermined efficiency requirement and a predetermined energy consumption threshold.

In another aspect, a system for determining a cleaning schedule for an asset is provided. In some aspects, the system can include a plurality of sensors arranged to monitor an asset and a computing system including at least one data processor and memory storing instructions, which when executed by the at least on data processor causes the at least one data processor to perform operations. In some aspects, the operations performed by the processor can include receiving, from the plurality of sensors, the data characterizing the operational efficiency of the asset, determining an operational efficiency of the asset determining an operational efficiency threshold characterizing an undesirable operating efficiency, determining, using an optimization algorithm, a cleaning schedule for the asset based on the operational efficiency of the asset and the operational efficiency threshold and providing the cleaning schedule.

In some aspects, the cleaning schedule includes one or more minor cleanings for non-invasive cleaning of the asset. In some aspects, the cleaning schedule includes one or more major cleaning for mechanical cleaning of the asset.

In some aspects, the operations performed by the processor can further include determining a predicted time to event corresponding to a time that the operational efficiency threshold will be reached and providing the time to event.

In some aspects, the operations performed by the processor can further include receiving, from the asset, data characterizing one or more operating states of the asset and determining the cleaning schedule using an optimization algorithm, based on the operational efficiency of the asset, the operational efficiency threshold and the data characterizing the one or more operating states of the asset.

In some aspects, the operations performed by the processor can further include determining, by the at least one data processor, using the optimization algorithm, an optimized operating schedule for operation of the asset in the one or more operating states. In some aspects, the predicted time to event can be determined based on the cleaning schedule and the optimized operating schedule.

In some aspects, the operations performed by the processor can further include determining an amount of fouling that has developed in the asset.

In some aspects, the asset can be a heat exchanger or a compressor, and the plurality of sensors include at least one of temperature sensors and pressure sensors.

In some aspects, the operational efficiency threshold can be determined based on at least one of historical operational data of the asset, a client preference, a predetermined efficiency requirement and a predetermined energy consumption threshold.

### DESCRIPTION OF THE DRAWINGS

FIG. 1 is a block diagram of an exemplary asset monitoring system as described herein, configured to monitor operational efficiency of an asset and determine a variety of non-invasive and invasive cleaning schedules for the asset;

FIG. 2 illustrates a plurality of graphs of exemplary non-invasive and invasive cleaning schedules for the asset determined by the asset monitoring system of FIG. 1;

FIG. 3 is an exemplary graph illustrating an operational efficiency of an asset over time, with the asset operating in a plurality of operating modes and predictive analytics performed by the asset monitoring systems described herein to predict future operational efficiency of the asset;

FIG. 4 is an exemplary graph illustrating prescriptive analytics performed by the asset monitoring systems described herein on the operational efficiency data of FIG. 3 to prescribe an operating schedule for the plurality of operating modes of the asset to optimize asset performance; and

FIG. 5 is a flow diagram illustrating an exemplary method for determining prescriptive non-invasive and invasive cleaning schedules for assets according to the systems and methods described herein.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Over the course of operating industrial assets, such as heat exchangers and compressors, can experience operational degradation called fouling, resulting in an accumulation of unwanted deposits or contaminants that can develop on the surfaces thereof. Fouling within industrial assets can affect operational efficiency of assets, increase operational costs and damage the assets. For example, fouling can hinder heat transfer efficiency in heat exchangers and can constrict flow passages within heat exchangers and compressors, leading to reduced flow rates, increased pressure drops, and potential operational issues such as cavitation. Fouling can occur either through impurities in what is being subject to heat, or biological depending on if it is subject to water, or other areas. Fouling can result in operational inefficiencies and operational failures if proper measures are not taken to remove the fouling from the assets either by way of non-invasive cleaning operations (e.g., decoking operations) or by way of robust mechanical cleaning of the assets. Traditionally, asset's fouling is dealt with retroactively, in response to the asset operating at an undesirable efficiency or in response to an operation failure that requires attention. Accordingly, it would be desirable to predict fouling within an asset and provide information regarding when to proactively clean the assets to prolong asset life, improve efficiency and reduce asset downtime.

The systems and methods described herein combine the use of sensors configured to monitor an asset and a computing system arranged to receive, from the sensors, data characterizing an operational efficiency of the asset. Using the data characterizing operational efficiency of the asset and an operational efficiency threshold characterizing an undesirable operating efficiency, the computing system can determine a variety of non-invasive and invasive cleaning schedules for the asset, as described in greater detail below.

The systems and methods described herein advantageously combine the use of machine learning algorithms with descriptive data characterizing asset efficiency/health to provide a variety of non-invasive and invasive cleaning schedules for the asset to prolong asset life, improve efficiency and reduce asset downtime. The systems and methods described herein can be applied to any industrial assets that experience performance degradation over time, resulting in reduced operational efficiency and/or assets that are susceptible to anomalous behavior. The asset monitoring systems and methods described leverage proactive/predictive models to provide intervention schedules aimed to manage fouling, increase efficiency and prolong asset life.

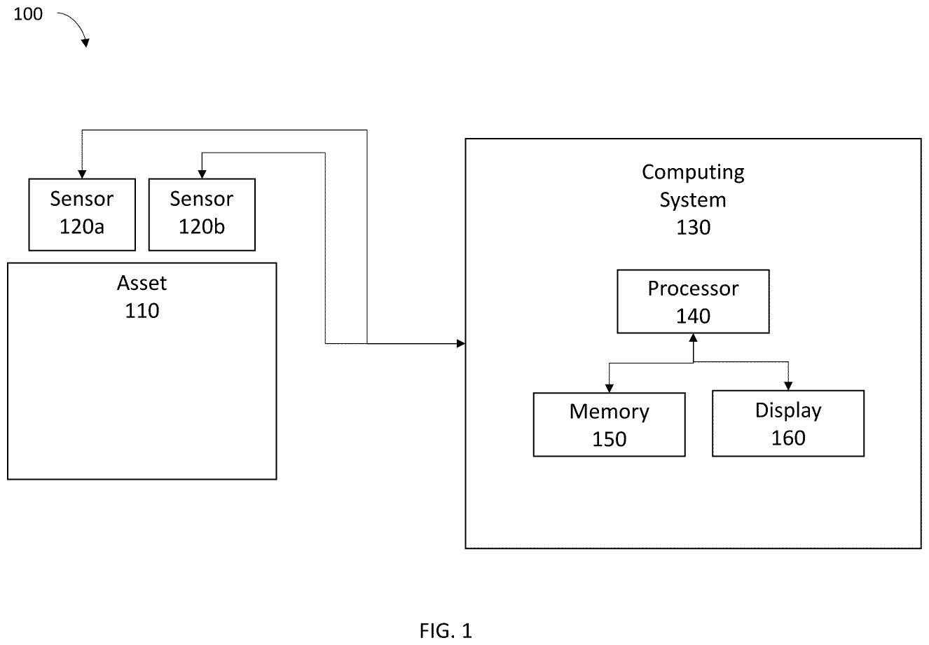

FIG. 1 illustrates an exemplary asset monitoring system 100 for determining a variety of non-invasive and invasive cleaning schedules for an asset 110 based on an operational efficiency of the asset 110 over time. As shown in FIG. 1, the system 100 can include a plurality of sensors 120a, 120b configured to monitor condition indicators (e.g., indicators of operational efficiency) of the asset 110 over time. In some aspects, the asset 110 can be an industrial asset (e.g., a heat exchanger, a compressor). As shown in FIG. 1, the plurality of sensors 120a, 120b can be configured detect a plurality of condition indicators of the asset 110 as it operates. The condition indicators monitored by the sensors 120a, 120b can be used by the system to determine changes in the asset's operational efficiency over time as the asset degrades. For example, in some aspects, the asset 100 can be a heat exchanger or a compressor and the plurality of sensors 120a, 120b can include temperature sensors and/or pressure sensors configured to measure a variety of temperatures and/or pressures of the asset 110 (e.g., inlet temperatures/pressures and outlet temperatures/pressures). Based on the temperature and/or pressure measurements, the system 100 can determine the asset's operational efficiency and/or the degradation of the asset 110 over time, as discussed in greater detail below. In some aspects, the condition indicators monitored by the sensors 120a, 120b can inform the system 100 as to how much fouling has developed within the asset 110, which can result in reduced operational efficiency and degradation of the system.

The system 100 can also include a computing system 130 including at least one data processor 140 and a memory 150 storing instructions. In some aspects, the computing system 130 can further include a user interface display 160. The computing system can receive the data characterizing the operational efficiency of the asset, acquired by the plurality of sensors 120a, 120b. Using the data received from the plurality of sensors 120a, 120b, the processor 140 can be configured to determine, an operational efficiency of the asset 110. For example, in a case where the plurality of sensors 120a, 120b are temperature sensors, the operational efficiency can be determined based on temperature ratios from the plurality of sensors 120a, 120b (e.g., using a logarithmic mean temperature difference (LMTD) method, or the like). In some aspects, the processor 140 can also determine an operational efficiency threshold characterizing an undesirable operating efficiency for the asset 110. In some aspects, the operational efficiency threshold can be determined based on historical operational data of the asset, a client preference, a predetermined efficiency requirement and a predetermined energy consumption threshold. For example, in some cases, the client may want the asset 110 to be operating with a certain level of efficiency in order to comply with efficiency standards in the industry or in order to reduce operational/energy costs. In some aspects, the operational efficiency threshold can be determined by the processor 140, using the measurements received from the plurality of sensors 120a, 120b. For example, in some aspects, the system 100 can be configured to determine the operational efficiency threshold based on a predetermined LMTD threshold that corresponds to a predetermined undesirable efficiency set by the system 100. The operational efficiency threshold can represent an operational efficiency that, when reached by the asset 110, would be undesirable and maintenance would be required to improve the performance of the asset 110.

Accordingly, in some aspects, based on the operational efficiency of the asset and the operational efficiency threshold, the processor 140 can determine a cleaning schedule for the asset 110 based on the operational efficiency of the asset over time and the operational efficiency threshold, and provide the cleaning schedule to a user, as discussed in greater detail below.

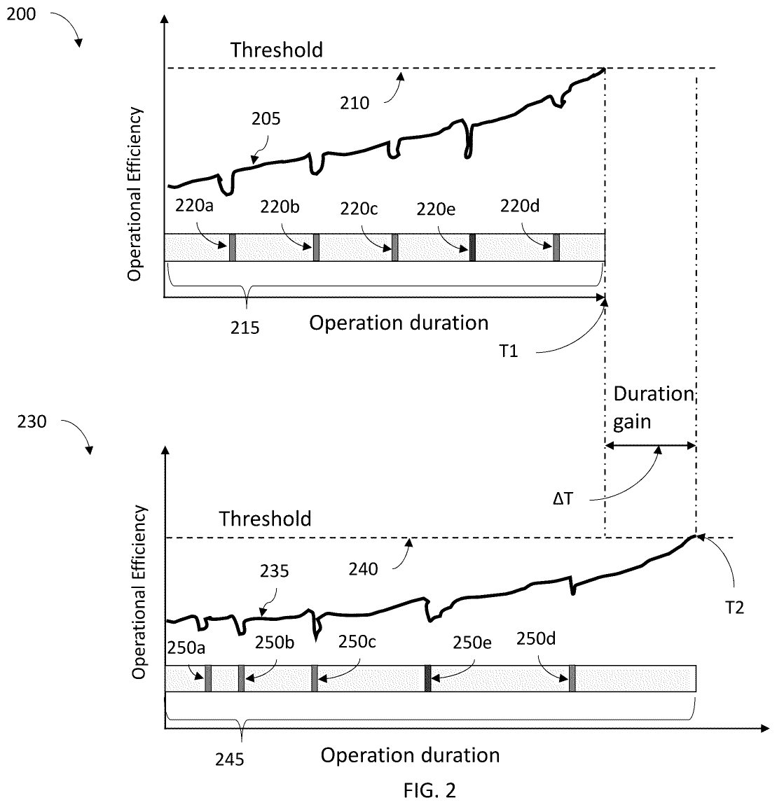

FIG. 2 shows two graphs 200, 230 of an operational efficiency of an asset over time. As shown in FIG. 2, the graphs 200, 230 can each include a cleaning schedule 215, 245, respectively that are determined using the systems and methods described herein (e.g., the asset monitoring system 100 of FIG. 1). The exemplary graphs 200, 230 shown in FIG. 2 will be described below with reference made to FIG. 1.

As described above, in some aspects, the systems described herein can include a plurality of sensors 120a, 120b configured to monitor the asset 110 for condition indicators (e.g., indicators of operational efficiency. For example, in a case where the asset 110 is a heat exchanger and the plurality of sensors 120a, 120b are temperature sensors, the temperature readings from the sensors can be received by the computing system 130. As shown in graph 200, using the temperature readings from the sensors, the processor 140 can determine an operational efficiency 205 of the asset over time. As described above, in some aspects, the operational efficiency 205 can be determined based on temperature ratios from the plurality of sensors 120a, 120b (e.g., using a logarithmic mean temperature difference (LMTD) method, or the like). The processor 140 can also determine an operational efficiency threshold 210 characterizing an undesirable operating efficiency for the asset. In some aspects, the operational efficiency threshold 210 can be determined based on a predetermined LMTD threshold. In some aspects, the operational efficiency threshold can be determined based on historical operational data of the asset, a client preference, a predetermined efficiency requirement and/or a predetermined energy consumption threshold. For example, the system 100 can determine, based on historical operational data of the asset 110 (stored in the memory 150 of the computing system 130 and/or stored in a remote database), that maintenance was required, or a fault occurred in the asset 110, when the asset 110 was operating above the operational efficiency threshold 210. In another example, if the client and/or industry standards require that the asset 110 operates with a certain level of efficiency (e.g., to ensure that energy consumption costs are minimized), the system 100 can determine the operational efficiency threshold 210 based on a user input indicating the client preference, predetermined efficiency requirement and/or a predetermined energy consumption threshold, as described above. In some aspects, the operational efficiency threshold 210 can further include a predicted time to event T1 corresponding to a time that the operational efficiency threshold 210 will be reached.

As shown in graph 200, the system 100 can also determine a cleaning schedule 215 for the asset based on the operational efficiency 205 of the asset and the operational efficiency threshold 210. The cleaning schedule 215 can represent a prescriptive schedule for cleaning the asset 110 throughout its operation, until the operational efficiency of the asset reaches the operational efficiency threshold 210. In some aspects, the cleaning schedule 215 can include one or more minor cleanings 220a-220d and/or one or more major cleanings 220e. In some aspects, the one or more minor cleanings 220a-220d and/or one or more major cleanings 220e of the cleaning schedule 215 can be determined by the processor 140 at regular intervals. However, in some aspects, the cleaning schedule can be determined by the processor 140 using an optimization algorithm, as described in greater detail below. The one or more minor cleanings 220a-220d within the cleaning schedule 215 can indicate to the user that a non-invasive cleaning of the asset 110 is required. In some aspects, the non-invasive cleaning operations to be performed during the one or more prescribed minor cleanings 220a-220d can include, but are not limited to chemical decoking, steam-air decoking, or in-spalling decoking. In some aspects, the systems and methods described herein can be configured to command the asset 110 to perform the one or more prescribed minor cleanings 220a-220d at their scheduled times, defined by the cleaning schedule 215, when a human operator is not available to clean the asset 110. In some aspects, the one or one or more major cleanings 220e within the cleaning schedule 215 can indicate to the user that a more robust/invasive cleaning of the asset 110 is required (e.g., due to excessive material fouling within the asset 110). In some aspects, the invasive cleaning operations to be performed during the one or more prescribed major cleanings 220e can include, but are not limited to a mechanical and/or manual cleaning of the asset by an operator. In some aspects, the graph 200 and/or the cleaning schedule 215 can be provided to the user interface display 160 of the system 100 to be viewed by the client/user. For example, in some cases, cleaning schedule 215 can be provided as one or more times in the future corresponding to prescribed times to perform the one or one or more minor/major cleanings.

As mentioned above, in some aspects, the cleaning schedule can be determined by the processor 140 using an optimization algorithm. Graph 230 illustrates this optimization process. As shown in Graph 230, the processor 140 can determine an operational efficiency 235 of the asset over time and an operational efficiency threshold 240 characterizing an undesirable operating efficiency for the asset. In some aspects, the operational efficiency 235 and the operational efficiency threshold 240 can be determined similarly to as described above in reference to graph 200. In the case of graph 230, the system 100 can also determine an optimized cleaning schedule 245 for the asset based on the operational efficiency 205 of the asset and the operational efficiency threshold 210. Similarly to the cleaning schedule 215, the optimized cleaning schedule 245 can include one or more minor cleanings 250a-250d and/or one or more major cleanings 250c. In some aspects, the operational efficiency threshold 210 can further include a predicted time to event T2 corresponding to a time that the operational efficiency threshold 210 will be reached if the optimized cleaning schedule 245 is prescribed. The optimized cleaning schedule 245 can be determined by the processor 140 using one or more optimization algorithms. In some aspects, the optimization algorithms can be trained using the operational efficiency data stored in the memory 150. For instance, in some aspects, the systems and methods described herein can perform simulations using the machine learning algorithms to optimize total operation duration with the intervention intervals (e.g., the one or more minor cleanings 250a-250d and/or one or more major cleanings 250c) as optimization variables. In some aspects, the machine learning/optimization algorithms can include a Monte Carlo algorithm, or the like, that indicates the optimal time to intervene, with either a minor cleaning or a major cleaning operation, to prolong the asset's operational duration. By using the machine learning/optimization algorithms as described herein, the system 100 can advantageously increase the operational duration of the asset 110. For example, as shown in FIG. 2, the predicted time to event if the cleaning schedule 215 is prescribed is T1 and the predicted time to event if the optimized cleaning schedule 225 is prescribed is T2. Accordingly, the predicted time to event can be increased by a ΔT (T2−T1) if the optimized cleaning schedule 245 is prescribed.

In some aspects, the asset being monitored (e.g., asset 110 of FIG. 1) can be configured to operate in a plurality of operating modes. For example, in some cases, the asset can be a heat exchanger that can operate in a first mode and a second mode. Accordingly, in some aspects, the systems and methods described herein (e.g., the computing system 130) can also be configured to receive data characterizing one or more operating states of the asset which can be used to generate the optimized cleaning schedules, as described in greater detail below. In some aspects, the data characterizing the one or more operating states of the asset can be received directly from the asset.

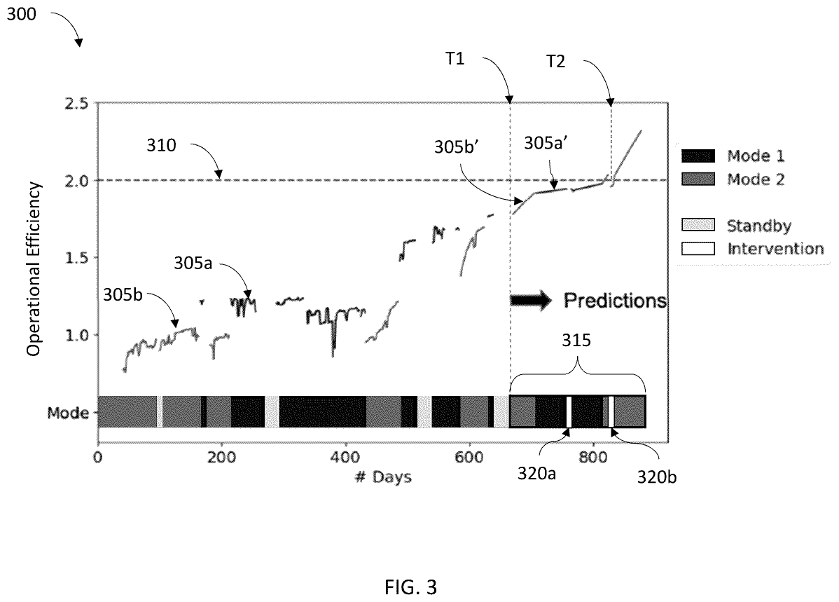

FIG. 3 shows another exemplary graph 300 illustrating an operational efficiency of an asset over time as the asset operates in a plurality of operating modes. The exemplary graph 300 shown in FIG. 3 will be described below with reference made to FIGS. 1-2. As shown in FIG. 3, the graph 300 includes a first operational efficiency 305a for the asset when operating in a first mode and a second operational efficiency 305b for the asset when operating in a second mode. In some aspects, the operational efficiency (shown on the Y-axis) can be measured in units of temperature, or it can be a unitless measure of operational efficiency. For example, in a case where the sensors monitoring the asset are temperature sensors and the operational efficiency is determined using LMTD, as described above, the operational efficiency can be measured in units of temperature. In some aspects, when the temperature sensors and the operational efficiency is determined using an LMTD ratio, the operational efficiency can be a unitless measure of efficiency. In another example, in a case where the asset is a compressor, or a pump, or the like, and the sensors monitoring the asset are pressure sensors, the operational efficiency can be a unitless measure of efficiency determined, for example, by comparing an actual pressure output of the asset a reference value or desired output. In some aspects, when the sensors are pressure sensors, the operational efficiency can also be a pressure difference measured in units of pressure. In some aspects, the processor 140 can receive the operational indicators from the plurality of sensors 120a, 120b over a period of time (e.g., from a day 0 up to a current date T1) and determine the operational efficiencies 305a, 305b of the asset over time and an operational efficiency threshold 310 characterizing an undesirable operating efficiency for the asset similarly to as described above in reference to FIGS. 1-2. In some aspects, as shown in FIG. 3, the data received from the sensors of the system 100 can also indicate times where the asset is operating on standby (or has stopped operating). As shown in graph 300, the asset can have a lower efficiency 305b while operating in the second mode and can have a higher efficiency 305a while operating in the first mode. The system 100 can also determine an optimized cleaning schedule 315 for the asset based on the operational efficiencies 305a, 305b of the asset and the operational efficiency threshold 310. Similarly to as described above, the optimized cleaning schedule 315 can include one or more cleanings 320a-320b. In some aspects, the one or more cleanings 320a-320b can include both minor and major cleanings, as described above. In some aspects, the operational efficiency threshold 310 can further include a predicted time to event T2 corresponding to a time that the operational efficiency threshold 310 will be reached if the optimized cleaning schedule 315 is prescribed. In some aspects, the optimized cleaning schedule 315 can be provided to the user interface to be viewed by the user, similarly to as described above. In some aspects, the user can interact with the display 160 to request information corresponding to the predicted time-to-event failure (at T2) of the asset during its operational window. In some aspects the user can also request, via the display 160, a forecast of the degradation profile of the asset with and/or without intervention as prescribed in the cleaning schedule 315. Based on the request provided by the user, the processor 140 can be configured to retrieve the data stored in the memory 150 of the computing system to provide predictive analytics regarding the predicted time-to-event failure (at T2) and the evolution of the operational efficiency of the asset with and/or without intervention.

In a case where the user wishes to operate the asset in the first and second modes as they have done in the past, the optimized cleaning schedule 315 can simply predict the future operating modes, corresponding operational efficiencies 305a′, 305b′ of the asset and the optimized cleaning schedule 315 using the optimization algorithms described herein. However, in some aspects, the user can interact with the display 160 to request that the system 100 propose a prescriptive operating schedule and cleaning schedule to operate and clean the asset in a manner that will best prolong the operational life of the asset. In this case, the systems and methods described herein can be configured to use the operational indicators received from the plurality of sensors 120a, 120b over a period of time (e.g., from a day 0 up to a current date T1) and the optimization algorithms described herein to further determine an optimized operation schedule for the asset along with the optimized operation schedule, as described in greater detail below.

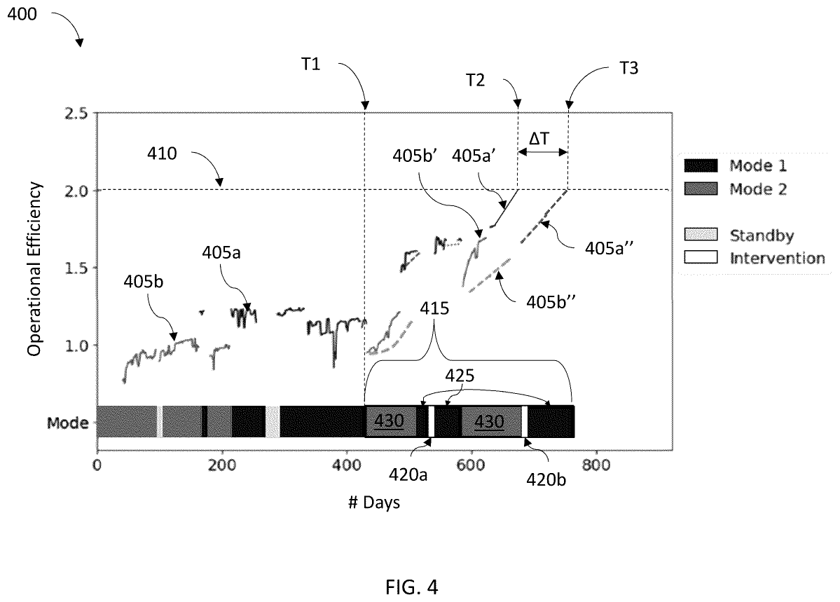

FIG. 4 shows another exemplary graph 400 illustrating an operational efficiency of an asset over time as the asset operates in a plurality of operating modes, similarly to as shown in FIG. 3. The exemplary graph 400 shown in FIG. 4 will be described below with reference made to FIGS. 1-3. As shown in FIG. 4, the graph 400 includes a first operational efficiency 405a for the asset when operating in a first mode and a second operational efficiency 405b for the asset when operating in a second mode. In some aspects, the processor 140 can receive the operational indicators from the plurality of sensors 120a, 120b over a period of time (e.g., from a day 0 up to a current date T1) and determine the operational efficiencies 405a, 405b of the asset over time and an operational efficiency threshold 410 characterizing an undesirable operating efficiency for the asset similarly to as described above. The data received from the sensors of the system 100 can also indicate times where the asset is operating on standby (or has stopped operating). As mentioned above, in some cases, the user of the systems and methods can interact with the display 160 to request that the system 100 propose a prescriptive schedule that includes both an optimized operating schedule and an optimized cleaning schedule to operate and clean the asset in a manner that will best prolong the operational life of the asset. In this case, the systems and methods described herein can be configured to use the operational indicators received from the plurality of sensors 120a, 120b over a period of time (e.g., from a day 0 up to a current date T1) and the optimization algorithms described herein to further determine an optimized schedule 415 for the asset. The optimized schedule 415 can include an optimized operating schedule that informs the user of the best ways to combine operation of the asset in the first and second operating modes in order to prolong the life of the asset. Additionally, the optimized schedule 415 includes one or more cleanings 420a-420b including a mixture of minor and/or major cleanings, similarly to as described above. For instance, the optimized schedule can indicate a plurality of prescriptive times 425 to operate the asset in the first operating mode and a plurality of prescriptive times 430 to operate the asset in the second operating mode.

Furthermore, in some aspects, the user can be given the option to prescribe any of the optimized operating schedule 425, 430 and the one or more cleanings 420a-420b. Accordingly, if the user provides an input to the user interface indicating that they would like to prescribe the one or more cleanings 420a-420b, but not the optimized operating schedules 425, 430, the system can be configured to determine a first predicted time to event T2 corresponding to a time that the operational efficiency threshold 410 will be reached if the one or more cleanings 420a-420b are prescribed, but the user wishes to operate the asset in the first and second modes as they have done in the past. In this case, the system can simply predict the future operating modes, corresponding operational efficiencies 405a′, 405b′ of the asset and the one or more cleanings 420a-420b using the optimization algorithms as described above. Alternatively, if the user provides an input to the user interface indicating that they would like to prescribe the complete optimized schedule 415 including the one or more cleanings 420a-420b and the optimized operating schedules 425, 430, the system can be configured to determine a second predicted time to event T3 corresponding to a time that the operational efficiency threshold 410 will be reached if the complete optimized schedule 415 is prescribed. In this case, the system can use the condition indicator data received from the sensors and the historical operational data received from the asset, along with the optimization algorithms as described above to predict the optimized operating schedules 425, 430, the corresponding operational efficiencies 405a″, 405b″ of the asset and the one or more cleanings 420a-420b. In some aspects, the optimization algorithms can be trained using the operational efficiency data as described above. Additionally, in some aspects, the optimization algorithms can be trained using historical operating schedules for the asset or other similar assets. For instance, in some aspects, the systems and methods described herein can perform simulations using the machine learning algorithms to optimize the operating schedules and the intervention intervals (e.g., the one or more minor/major cleanings 420a-420b) as optimization variables. By prescribing the complete optimized schedule 415, the system 100 can advantageously increase the operational duration of the asset 110. For example, as shown in FIG. 4, the predicted time to event if the one or more cleanings 420a-420b are prescribed, but not the optimized operating schedules 425, 430, is T2 and the predicted time to event if the complete optimized schedule 415 is prescribed is T3. Accordingly, the predicted time to event can be increased by a ΔT (T3−T2) if the complete optimized schedule 415 is prescribed. In some aspects, the predicted results based on prescription of only portions of the optimized schedule 415 and the predicted results based on prescription of the complete optimized schedule 415 (including both the predicted times to event T2 and T3 and the ΔT) can be provided to the user interface to be viewed by the user.

As described above, the cleaning events described herein can include mechanical cleanings which require a user as well as alternative intervention methods, such as the non-invasive minor cleanings when an operator is not present. For instance, the user can request, via a user interface display of the systems described here, for the asset monitoring system to include a prescription of a minor cleaning of the asset in the cleaning schedules described herein, such as decoking (e.g., in-spalling, steam-air decoking, chemical decoking, or the like). Both the minor and major cleaning events prescribed by the systems and methods described herein advantageously allow users to prolong the operating window of their assets while maintaining an operational efficiency under the determined operational efficiency thresholds.

In some aspects, the systems and methods described herein can further be configured to monitor a fleet of assets, where each asset can have an operational efficiency different from the other, which is dependent on differing degrees of fouling. Traditionally, in this case, it can be difficult for users to determine the best cleaning schedules for each asset in the fleet. Accordingly, by leveraging the machine learning and optimization capabilities of the systems and methods described herein, operational data from the fleet of assets and operational efficiency data from the sensors monitoring the fleet can be used to train the systems described herein to produce a robust network of systems capable to providing descriptive, predictive and prescriptive analytical models for optimizing asset health and performance.

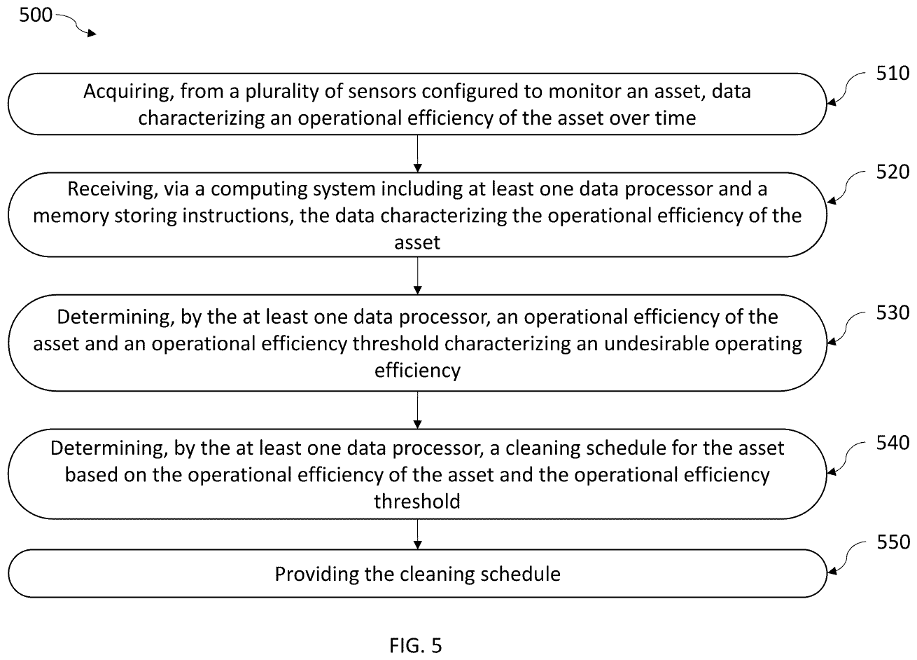

FIG. 5 is a flow diagram illustrating an exemplary method 500 for determining prescriptive minor and major (e.g., non-invasive and invasive) cleaning schedules for assets according to the systems and methods described herein. In some aspects, the method 500 can include a step 510 of acquiring, from a plurality of sensors configured to monitor an asset, data characterizing an operational efficiency of the asset over time. The plurality of sensors can include temperature sensors and/or pressure sensors, however, the use of other sensor types capable of monitoring operational efficiency are also realized.

The method 500 can also include a step 520 of receiving, via a computing system including at least one data processor and a memory storing instructions, the data characterizing the operational efficiency of the asset. In some aspects, the asset monitoring system can store data corresponding to the operational efficiency of the asset over the period of time it operates.

The method 500 can also include a method step 530 of determining, by the at least one data processor, an operational efficiency of the asset and an operational efficiency threshold characterizing an undesirable operating efficiency, as described above in reference to FIGS. 1-4.

The method 500 can also include a step 540 of determining a cleaning schedule for the asset based on the operational efficiency and the operational efficiency threshold. In some aspects, the cleaning schedule can be determined using an optimization algorithm as described herein. In some aspects, the method can also include a step of determining a predicted time to event corresponding to a time that the operational efficiency threshold will be reached. Additionally, in some aspects, step 540 can further include determining a plurality of cleaning schedules having differing levels of intervention and/or differing predicted times to failure, which can be provided to the user interface to be viewed and selected by the user. In some aspects, the asset can include multiple operating modes that may require specific cleaning methods or an optimized approach to cleaning the asset in order to prolong its operational duration. In this case, the method can also include a step of receiving, from the asset, data characterizing one or more operating states of the asset and determining the cleaning schedule using an optimization algorithm, based on the operational efficiency of the asset, the operational efficiency threshold and the data characterizing the one or more operating states of the asset.

The method 500 can also include a step 550 of providing the one or more cleaning schedules to a user via a user interface display.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
acquiring, from a plurality of sensors configured to monitor an asset, data characterizing an operational efficiency of the asset over time;
receiving, via a computing system including at least one data processor and a memory storing instructions, the data characterizing the operational efficiency of the asset;
determining, by the at least one data processor, an operational efficiency of the asset and an operational efficiency threshold characterizing an undesirable operating efficiency;
determining, by the at least one data processor, a cleaning schedule for the asset based on the operational efficiency of the asset and the operational efficiency threshold; and
providing the cleaning schedule.

2. The method of claim 1, wherein the cleaning schedule comprises one or more minor cleanings for non-invasive cleaning of the asset.

3. The method of claim 2, wherein the cleaning schedule comprises one or more major cleaning for mechanical cleaning of the asset.

4. The method of claim 1, further comprising:
determining, by the at least one data processor, a predicted time to event corresponding to a time that the operational efficiency threshold will be reached; and
providing the time to event.

5. The method of claim 4, further comprising:
receiving, via the computing system, from the asset, data characterizing one or more operating states of the asset; and
determining the cleaning schedule, by the at least one data processor, using an optimization algorithm, based on the operational efficiency of the asset, the operational efficiency threshold and the data characterizing the one or more operating states of the asset.

6. The method of claim 5, further comprising: determining, by the at least one data processor, using the optimization algorithm, an optimized operating schedule for operation of the asset in the one or more operating states.

7. The method of claim 6, wherein the predicted time to event is determined based on the cleaning schedule and the optimized operating schedule.

8. The method of claim 1, further comprising: determining, by the at least one data processor, an amount of fouling that has developed in the asset.

9. The method of claim 1, wherein the asset is a heat exchanger or a compressor, and the plurality of sensors comprise at least one of temperature sensors and pressure sensors.

10. The method of claim 1, wherein the operational efficiency threshold is determined based on at least one of historical operational data of the asset, a client preference, a predetermined efficiency requirement and a predetermined energy consumption threshold.

11. A system comprising:
a plurality of sensors configured to monitor an asset; and
a computing system including at least one data processor and memory storing instructions, which when executed by the at least on data processor causes the at least one data processor to perform operations comprising:
receiving, from the plurality of sensors, the data characterizing the operational efficiency of the asset;
determining an operational efficiency of the asset;
determining an operational efficiency threshold characterizing an undesirable operating efficiency;
determining, using an optimization algorithm, a cleaning schedule for the asset based on the operational efficiency of the asset and the operational efficiency threshold; and
providing the cleaning schedule.

12. The system of claim 11, wherein the cleaning schedule comprises one or more minor cleanings for non-invasive cleaning of the asset.

13. The system of claim 12, wherein the cleaning schedule comprises one or more major cleaning for mechanical cleaning of the asset.

14. The system of claim 11, wherein the operations performed by the at least one data processor further comprise:
determining a predicted time to event corresponding to a time that the operational efficiency threshold will be reached; and
providing the time to event.

15. The system of claim 14, wherein the operations performed by the at least one data processor further comprise:
receiving, from the asset, data characterizing one or more operating states of the asset; and
determining the cleaning schedule using an optimization algorithm, based on the operational efficiency of the asset, the operational efficiency threshold and the data characterizing the one or more operating states of the asset.

16. The system of claim 15, wherein the operations performed by the at least one data processor further comprise: determining, by the at least one data processor, using the optimization algorithm, an optimized operating schedule for operation of the asset in the one or more operating states.

17. The system of claim 16, wherein the predicted time to event is determined based on the cleaning schedule and the optimized operating schedule.

18. The system of claim 11, wherein the operations performed by the at least one data processor further comprise: determining an amount of fouling that has developed in the asset.

19. The system of claim 11, wherein the asset is a heat exchanger or a compressor, and the plurality of sensors comprise at least one of temperature sensors and pressure sensors.

20. The system of claim 11, wherein the operational efficiency threshold is determined based on at least one of historical operational data of the asset, a client preference, a predetermined efficiency requirement and a predetermined energy consumption threshold.
